(19) United States
(12) Patent Application Publication
(10) Pub. No.: US 2016/0292105 A1
(43) Pub. Date: Oct. 6, 2016

(54) DEVICE CONTROL SYSTEM AND REFRIGERATOR USING SAME

(71) Applicant: SAMSUNG ELECTRONICS CO., LTD., Gyeonggi-do (KR)

(72) Inventors: Yoji Imahori, Kanagawa (JP); Masanaga Tanaka, Kanagawa (JP); Soda Yasushi, Kanagawa (JP); Toshiaki Suzuki, Kanagawa (JP)

(21) Appl. No.: 15/038,444

(22) PCT Filed: Nov. 20, 2014
(86) PCT No.: PCT/KR2014/011217

§ 371 Date: May 20, 2016

(30) Foreign Application Priority Data
Nov. 22, 2013 (JP) 2013-241477
Dec. 9, 2013 (JP) 2013-253779
Jul. 28, 2014 (JP) 2014-152712
Nov. 20, 2014 (JP) 10-2014-0162723

(51) Int. Cl. G06F 13/362; G06F 13/42; F25D 29/00; G06F 3/06

(52) U.S. Cl. CPC G06F 13/362; G06F 3/061; G06F 3/0647; G06F 3/0683; G06F 13/4282; F25D 29/00; F25D 2700/02

(57) ABSTRACT

The present invention continuously operates remaining slave devices except for abnormal slave devices and easily detects the abnormal slave devices, and comprises: a plurality of slave devices; a master device for controlling the plurality of slave devices; a transmission line including a main transmission line connected to the master device, and a plurality of sub-transmission lines branched from the main transmission line and connecting the plurality of slave devices in series, so as to enable data communication between the plurality of slave devices and the master device and to enable mutual data communication between the plurality of slave devices; and a blocking unit interposed between the main transmission line and each of the plurality of sub-transmission lines so as to enable the separation of the sub-transmission lines from the main transmission line.

### TECHNICAL FIELD

The present invention relates to a device control system including a plurality of slave devices and a master device and a refrigerator using the same.

### BACKGROUND ART

Recently, a refrigerator having a central processing unit (CPU) and a communication circuit respectively installed in slave devices that perform predetermined functions, such as a refrigerating cycle related to cooling, refrigerator inside lighting, a fan, a refrigerator inner or outer sensor, a door switch, etc. is becoming popular. That is, a refrigerator has a structure in which a plurality of CPUs and communication circuits are mounted in one refrigerator (see Patent document 1). For example, a refrigerator has a so-called centralized control method, whereby the refrigerator further includes a master device for controlling each of the slave devices, and thus each slave device can be individually controlled.

In the conventional refrigerator having the above control method, when an abnormality occurs in one slave device, the supply of power to all slave devices is stopped.

However, in such a refrigerator, even though functions of abnormal slave devices are not related to a basic function of the refrigerator related to cooling, such as a refrigerating cycle and the basic function of the refrigerator itself can be performed, all functions of the refrigerator are stopped until the abnormal slave devices are restored to a normal state so that the inside of the refrigerator cannot be cooled.

### PRIOR-ART DOCUMENT

### Patent Document

Japanese Patent Laid-open Publication No. 2013-61104

### DISCLOSURE

### Technical Problem

The present invention is directed to providing continuously operating of abnormal slave devices or remaining slave devices excluding a minimum of slave devices including the abnormal slave devices and easily detecting of the abnormal slave devices.

### Technical Solution

One aspect of the present invention provides a refrigerator including: a plurality of storage compartments; a plurality of slave devices installed in each of the plurality of storage compartments and performing functions of the refrigerator; a master device controlling the plurality of slave devices; a transmission line including a main transmission line connected to the master device and a plurality of sub-transmission lines branched from the main transmission line and connecting the plurality of slave devices in series, so as to enable data communication between the plurality of slave devices and the master device and to enable mutual data communication between the plurality of slave devices; and a blocking unit interposed between the main transmission line and each of the plurality of sub-transmission lines such that the sub-transmission lines are separable from the main transmission line, wherein the plurality of sub-transmission lines may be serially connected to the plurality of slave devices installed in each of the plurality of storage compartments.

According to the refrigerator having the above configuration, since the plurality of sub-transmission lines that serially connect the plurality of slave devices installed in each of the plurality of storage compartments are configured to be separated from the main transmission line by the blocking units, remaining storage compartments, excluding the storage compartment in which abnormal slave devices are installed, may be continuously operated. In addition, in this state, the abnormal slave devices may be specified from among the slave devices installed at the sub-transmission lines separated from the main transmission line so that the abnormal slave devices may be easily specified. In addition, since the sub-transmission lines are installed in each of the storage compartments, manufacture of the refrigerator including wiring of the transmission line may be easily performed. Furthermore, a terminating connector may be unnecessary. In addition, a master slave method is employed in the refrigerator so that a diameter of a bundle of harness wiring that constitutes the main transmission line and the sub-transmission lines may be minimized, foam defects of a foam insulating material (a urethane foam, etc.) may be reduced, a problem of dew condensation does not occur and thicknesses of the foam insulating material and walls may be reduced.

The blocking units may be installed at inner walls of the storage compartments.

Thus, work for separating the sub-transmission lines may be easily performed.

The master device, in a state in which one among the plurality of sub-transmission lines is separated from the main transmission line by the blocking unit, may continuously operate using the slave devices connected to the remaining sub-transmission lines.

The blocking unit may include a connector to which an additional slave device or an external device is connectable.

The blocking unit may include a first connector installed in a state in which one end of a main transmission line that constitutes the main transmission line and one end of each of sub-transmission lines that constitute the sub-transmission lines are separated from each other, and a second connector which is installed to be attachable to and detachable from the first connector and in which a connection line for connecting one end of the main transmission line and one end of each of the sub-transmission line is installed.

An access connector may be installed in each of the plurality of sub-transmission lines such that the plurality of slave devices connected to each of the plurality of sub-transmission lines are individually detachable from one another.

Another aspect of the present invention provides a refrigerator including: a plurality of storage compartments; a plurality of slave devices installed in each of the plurality of storage compartments and each including a central processing unit (CPU), a communication circuit, an operating portion for performing a specific function, and a switch for switching power of the operating portion on/off; a master device controlling the plurality of slave devices; a transmission line enabling data communication between the plurality of slave devices and the master device and enabling data communication between the plurality of slave devices; and a current detector installed on the transmission line and detecting a current flowing through the transmission line, wherein the master device may convert the plurality of slave devices to be in an initial mode, in which no power is supplied to operating portions and functions of the slave devices are not operated by switches, and a normal mode, in which power is supplied to the operating portions and the functions of the slave devices are operated by the switches, and when the master device converts one among the slave devices from the initial mode into the normal mode, the master device may check whether a current value that is equal to or higher than a threshold value is detected using the current detector, and as a result of the checking, when the current value equal to or higher than the threshold value is detected, the master device may determine the slave devices as abnormal slave devices and may convert only remaining normal slave devices to be in the normal mode.

When the master device converts the plurality of slave devices from the initial mode into the normal mode and the abnormal slave devices are detected, the master device may convert all of the plurality of slave devices to be in the initial mode and then may convert the normal slave devices excluding the abnormal slave devices to be in the normal mode.

Another aspect of the present invention provides a refrigerator including: a plurality of storage compartments; a plurality of slave devices installed in each of the plurality of storage compartments and each including a central processing unit (CPU), a communication circuit, and an operating portion for performing a specific function; a master device controlling the plurality of slave devices; and a transmission line enabling data communication between the plurality of slave devices and the master device and enabling data communication between the plurality of slave devices, wherein the master device may convert the plurality of slave devices to be in an initial mode, in which each of the slave device performs only data receiving, and a normal mode, in which each of the slave device performs data transceiving, and when the master device converts one among the slave devices from the initial mode into the normal mode and then data communication with the slave device is disabled, the master device may determine the slave devices as abnormal slave devices and may convert only remaining normal slave devices to be in the normal mode.

One among the plurality of slave devices may be set as a preliminary master device, and when an abnormality occurs in the master device, the preliminary master device may continuously operate by maintaining communication with the normal slave devices.

Another aspect of the present invention provides a device control system including: a plurality of slave devices; a master device for controlling the plurality of slave devices; a transmission line including a main transmission line connected to the master device and a plurality of sub-transmission lines branched from the main transmission line and connecting the plurality of slave devices in series, so as to enable data communication between the plurality of slave devices and the master device and to enable mutual data communication between the plurality of slave devices; and a blocking unit interposed between the main transmission line and each of the plurality of sub-transmission lines such that the sub-transmission lines are separable from the main transmission line.

According to the device control system, since a plurality of sub-transmission lines that serially connect a plurality of slave devices installed in each of a plurality of storage compartments are configured to be separated from the main transmission line by blocking units, abnormal slave devices or the remaining slave devices excluding a minimum of slave devices including the abnormal slave devices may be continuously operated. In addition, in this state, the abnormal slave devices may be specified from among the slave devices installed in the sub-transmission lines separated from the main transmission line so that the abnormal slave devices may be easily specified.

In addition, the master device, in a state in which one among the plurality of sub-transmission lines is separated from the main transmission line by the blocking unit, may continuously operate using the slave devices connected to the remaining sub-transmission lines. In this case, the master device may specify the sub-transmission lines separated by the blocking unit, may convert the sub-transmission line into a control sequence by only the sub-transmission lines in a connection state excluding the separated sub-transmission lines, and may continuously operate using the slave devices installed on the sub-transmission lines in the connection state.

The blocking unit may include a connector to which an additional slave device or an external device is connectable. Thus, connection of an additional slave device, for example, connection of an external device, such as a diagnosis device, may be easily performed.

An access connector may be installed in each of the plurality of sub-transmission lines such that the plurality of slave devices connected to each of the plurality of sub-transmission lines are individually detachable from one another. Thus, each of the slave devices installed in each of the sub-transmission lines may be easily detached, and replacing of abnormal slave devices may be easily performed.

In addition, in the conventional refrigerator, although an operating portion of one of the slave devices is shorted, since a CPU of each of the slave device detects short defects of the operating portion and cannot perform a power off, an overcurrent flows through transmission lines that connect between the slave devices. Then, due to an overcurrent protection circuit of a power supply portion, a supply of power to all of the slave devices including the remaining slave devices excluding the abnormal slave devices is stopped. In addition, even though functions of the abnormal slave devices are not related to a basic function of the refrigerator related to cooling, such as a refrigerating cycle, and the basic function of the refrigerator itself may be performed, because all functions of the refrigerator are stopped until the abnormal slave devices are restored to a normal state, an inside of the refrigerator may not be cooled.

Another aspect of the present invention provides a device control system including: a plurality of slave devices, each including a central processing unit (CPU), a communication circuit, an operating portion for performing a specific function, and a switch for switching power of the operating portion on/off; a master device controlling the plurality of slave devices; a transmission line enabling data communication between the plurality of slave devices and the master device and enabling data communication between the plurality of slave devices; and a current detector installed on the transmission line and detecting a current flowing through the transmission line, wherein the master device may convert the plurality of slave devices to be in an initial mode, in which no power is supplied to operating portions and functions of the slave devices are not operated by switches, and a normal mode in which power is supplied to the operating portions and the functions of the slave devices are operated by the switches, and when the master device converts one among the slave devices from the initial mode into the normal mode, the master device may check whether a current value that is equal to or higher than a threshold value is detected using the current detector, and as a result of the checking, when the current value equal to or higher than the threshold value is detected, the master device may determine the slave devices as abnormal slave devices and may convert only remaining normal slave devices to be in the normal mode.

According to the device control system having the above configuration, even when an abnormality, such as overcurrent, occurs in a part of the plurality of slave devices that constitute the refrigerator, since slave devices are determined as the abnormal slave devices and the remaining normal slave devices are converted to be in the normal mode and perform their functions, functions of the normal slave devices excluding the abnormal slave devices are performed so that an inside of the refrigerator may be prevented from failing to be cooled.

When the master device converts the plurality of slave devices from the initial mode into the normal mode and the abnormal slave devices are detected, the master device may convert all of the plurality of slave devices to be in the initial mode and then may convert the normal slave devices excluding the abnormal slave devices to be in the normal mode.

One among the plurality of slave devices may be set as a preliminary master device, and when an abnormality occurs in the master device, the preliminary master device may continuously operate by maintaining communication with the normal slave devices.

Another aspect of the present invention provides a device control system including: a plurality of slave devices, each including a central processing unit (CPU), a communication circuit, and an operating portion for performing a specific function; a master device controlling the plurality of slave devices; and a transmission line enabling data communication between the plurality of slave devices and the master device and enabling data communication between the plurality of slave devices, wherein the master device may convert the plurality of slave devices to be in an initial mode, in which each of the slave device performs only data receiving, and a normal mode, in which each of the slave device performs data transceiving, and when the master device converts one among the slave devices from the initial mode into the normal mode and then data communication with the slave device is disabled, the master device may determine the slave devices as abnormal slave devices and may convert only remaining normal slave devices to be in the normal mode.

According to the device control system having the above configuration, even when an abnormality, such as communication disabling or a failure in the communication circuit, occurs in a part of the plurality of slave devices that constitute the refrigerator, since slave devices are determined as the abnormal slave devices, and the remaining normal slave devices are converted into the normal mode and functions of the slave devices are performed, functions of the normal slave devices excluding the abnormal slave devices are performed, and an inside of the refrigerator may be prevented from failing to be cooled. In addition, since the current detector need not be installed, the number of components may be minimized, and simplification of the refrigerator may be achieved.

When the master device converts the plurality of slave devices from the initial mode into the normal mode and the abnormal slave devices are detected, the master device may convert all of the plurality of slave devices to be in the initial mode and then may convert the normal slave devices excluding the abnormal slave devices to be in the normal mode. Thus, even when the master device and the plurality of slave devices are connected in a loop shape to one another by one transmission line, the abnormal slave devices may be exactly detected, and only the remaining normal slave devices may be converted into the normal mode, and even when an abnormality occurs in the part of the plurality of slave devices that constitute the refrigerator, an inside of the refrigerator may be prevented from failing to be cooled.

The master device may convert the normal slave devices to be in the normal mode and then may alternately convert the abnormal slave devices to be in the initial mode and the normal mode on a predetermined cycle to check whether an abnormality is solved. Thus, when the abnormality of the abnormal slave devices is a temporary abnormality, functions of all slave devices may be performed after the abnormality is solved.

One among the plurality of slave devices may be set as a preliminary master device, and when an abnormality occurs in the master device, the preliminary master device may continuously operate by maintaining communication with the normal slave devices. According to the device control system having the above configuration, even when an abnormality, such as communication disabling or a failure in the communication circuit, occurs in the master device, the preliminary master device replaces the master device and maintains communication with the normal slave device so that functions of the normal slave devices may be performed and the inside of the refrigerator may be prevented from failing to be cooled.

### Advantageous Effects

According to the present invention having the above configuration, a plurality of sub-transmission lines serially connecting a plurality of slave devices installed in each of a plurality of storage compartments are configured to be separated from a main transmission line using a blocking unit so that remaining storage compartments except for a storage compartment in which abnormal slave devices are installed can be continuously operated, and furthermore, the abnormal slave devices can be easily specified.

### DESCRIPTION OF DRAWINGS

FIG. 1 is a schematic view illustrating a configuration of a refrigerator according to an embodiment.

FIG. 2 is a schematic view illustrating a configuration of a blocking mechanism according to an embodiment.

FIG. 3 is a schematic view illustrating a modified example of a blocking mechanism.

FIG. 4 is a schematic view illustrating a configuration of a refrigerator according to a modified embodiment.

FIG. 5 is a schematic view illustrating a configuration of a refrigerator according to an embodiment.

FIG. 6 is a schematic view illustrating a configuration of slave devices according to an embodiment.

FIG. 7 is a schematic view illustrating a configuration and process of slave devices according to an embodiment.

FIG. 8 is a view illustrating an operating flow of slave devices according to an embodiment.

FIG. 9 is a view illustrating a functional configuration of a master device according to an embodiment.

FIG. 10 is a view illustrating an operating flow of a master device according to an embodiment.

FIG. 11 is a view illustrating control of a refrigerator according to an embodiment.

FIG. 12 is a view illustrating control of a refrigerator according to a modified embodiment.

FIG. 13 is a view illustrating control of a refrigerator according to a modified embodiment.

### MODES OF THE INVENTION

### First Embodiment

Hereinafter, a refrigerator using a device control system according to a first embodiment of the present invention will be described with reference to the attached drawings.

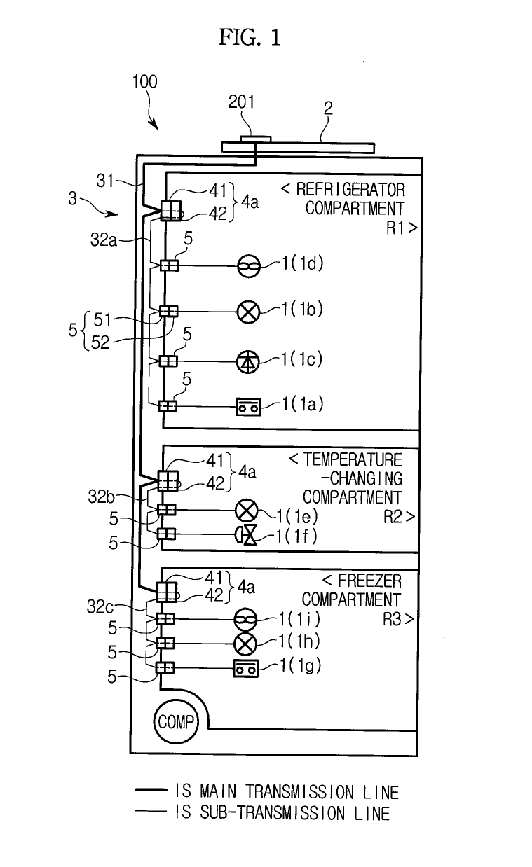

A refrigerator 100 according to the current embodiment including a plurality of storage compartments (in the current embodiment, a refrigerator compartment R1, a temperature-changing compartment R2, and a freezer compartment R3), a plurality of slave devices 1 installed in the plurality of storage compartments R1 to R3, a master device 2 that controls the plurality of slave devices 1, and a transmission line 3 that connects the plurality of slave devices 1 and the master device 2, as illustrated in FIG. 1, has a so-called autonomous distributed control method.

In addition, the transmission line 3 has a power line and a bus line that enable data communication between the plurality of slave devices 1 and data communication between the plurality of slave devices 1 and the master device 2. In the current embodiment, the power line includes two power lines, and the bus line includes one communication line. The transmission line 3 includes a total of three wire harnesses. Thus, a diameter of a bundle of the transmission line 3 may be set to be in the range of 3 to 4 mm, and a diameter of the transmission line 3 may be reduced. As a result, a wall of the refrigerator 100 may be made thin so that an internal capacity of the refrigerator 100 may be increased and foam defects of a foam insulating material (a urethane foam, etc.) installed at an inside of the wall may be reduced. In addition, the thickness of the foam insulating material deposited in the inside of the wall of the refrigerator 100 may be reduced to be in the range of, for example, 20 to 30 mm.

The plurality of slave devices 1 are devices that each have a central processing units (CPU) and a communication circuit, and perform a part of functions of the refrigerator 100. The slave devices 1 installed in the refrigerator compartment R1 include, for example, a refrigerator compartment door switch 1a, a refrigerator compartment temperature sensor (a refrigerator inner temperature sensor) 1b, a refrigerator compartment lighting device (a light emitting diode (LED)) 1c, a fan (a refrigerator compartment fan) 1d, etc. The slave devices 1 installed in the temperature-changing compartment R2 include a temperature-changing compartment temperature sensor (a refrigerator inner temperature sensor) 1e, a damper 1f, etc. The slave devices 1 installed in the freezer compartment R3 include, for example, a defrosting switch 1g, a freezer compartment temperature sensor (a refrigerator inner temperature sensor) 1h, a fan (a refrigerator compartment fan) 1i, etc. Moreover, an inverter, a condenser fan, an evaporator inlet temperature sensor, a defrosting sensor, a defrosting heater, a refrigerator outer or inner sensor, a refrigerator outer humidity sensor, a manipulation display panel, etc. are the slave devices 1. Here, in a control board for the slave devices 1, a direct current (DC)-based control board through which a DC flows is disposed in the refrigerator because it has a small explosion-proof energy, and an alternating current (AC)-based control board (for example, a control board for a defrosting heater) through which an AC flows is disposed outside the refrigerator because it has a large explosion-proof energy.

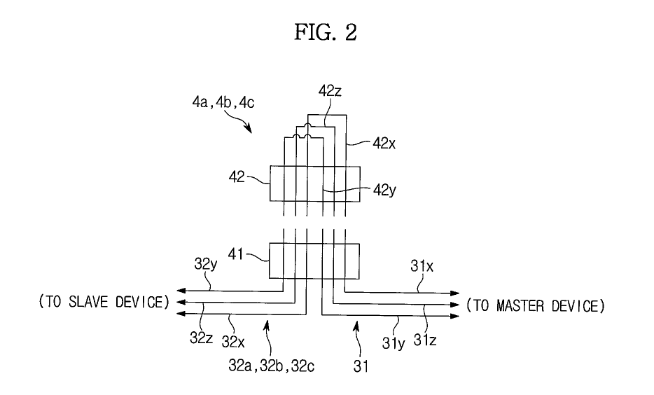

The master device 2 performs data communication with each of the slave devices 1 through local interconnect network (LIN) communication, as illustrated in FIG. 2. The master device 2 in the current embodiment is configured by a control board installed at a top surface or a rear surface of the refrigerator 100. Also, the master device 2 may be installed on a control board installed at the slave device 1 (for example, an inverter).

In addition, the master device 2 that is a computer circuit including a CPU 201, an internal memory, an analog-to-digital (AD) converter, an input/output interface, etc. performs functions including controlling the plurality of slave devices 1 when the CPU and peripheral devices of the master device 2 cooperate based on a predetermined program stored in the internal memory.

Data communication between the plurality of slave devices 1 and the master device 2 according to the current embodiment is communication in which data transmission polling is performed on the slave devices 1 from the master device 2 at a predetermined cycle and the slave devices 1 acknowledge (ACK) the data transmission polling. In addition, data communication between the plurality of slave devices 1 is performed through the bus line. In detail, each of the slave devices 1 outputs data at a predetermined cycle, and the remaining slave devices 1 acquire necessary data from the output data.

In the refrigerator 100 according to the current embodiment, the transmission line 3 includes a main transmission line 31 connected to the master device 2 and a plurality of sub-transmission lines 32, which are branched from the main transmission line 31 and serially connect the plurality of slave devices 1 installed in each of the plurality of storage compartments (the refrigerator compartment R1, the temperature-changing compartment R2, and the freezer compartment R3) in a daisy chain. In addition, the plurality of sub-transmission lines 32 are connected to the main transmission line 31 in a daisy chain.

In detail, the plurality of sub-transmission lines 32 include a sub-transmission line 32a that serially connects the plurality of slave devices 1 (for example, the door switch 1a, the temperature sensor 1b, the LED 1c, the fan 1d, etc.) installed in the refrigerator compartment R1, a sub-transmission line 32b that serially connects the slave devices 1 (for example, the temperature sensor 1e, a damper 1f, etc.) installed in the temperature-changing compartment R2, and a sub-transmission line 32c that serially connects the plurality of slave devices 1 (the defrosting switch 1g, the temperature sensor 1h, the fan 1i, etc.) installed in the freezer compartment R3.

In addition, blocking units 4a to 4c that enable the sub-transmission lines 32a to 32c to be separated from the main transmission line 31 are interposed between the main transmission line 31 and each of the plurality of sub-transmission lines 32a to 32c.

The blocking units 4a to 4c are installed in connection portions of each of the sub-transmission lines 32a to 32c and the main transmission line 31 and may independently separate the sub-transmission lines 32a to 32c from one another.

In detail, the blocking units 4a to 4c include a first connector 41 in which one end of each of main power lines 31x and 31y and a main communication line 31z that constitute the main transmission line 31 are separated from each other and installed and one end of each of sub-power lines 32x and 32y and a sub-communication line 32z that constitute the sub-transmission lines 32a to 32c are separated from each other and installed, and a second connector 42, which is installed to be attachable to and detachable from the first connector 41 and in which connection lines 42x, 42y, and 42z for connecting the one end of each of the main power lines 31x and 31y and the main communication line 31z with the one end of each of the sub-power lines 32x and 32y and the sub-communication line 32z are installed, as illustrated in FIG. 2.

In the blocking units 4a to 4c, in a state in which the second connector 42 is attached to the first connector 41, the one end of each of the main power lines 31x and 31y and the main communication line 31z of the first connector 41 and the one end of each of the sub-power lines 32x and 32y and the sub-communication line 32z are connected to one another by the connection lines 42x, 42y, and 42z of the second connector 42, and in a state in which the second connector 42 is detached from the first connector 41, the one end of each of the main power lines 31x and 31y, the main communication line 31z of the first connector 41 and the one end of each of the sub-power lines 32x and 32y and the sub-communication line 32z are blocked and separated from one another.

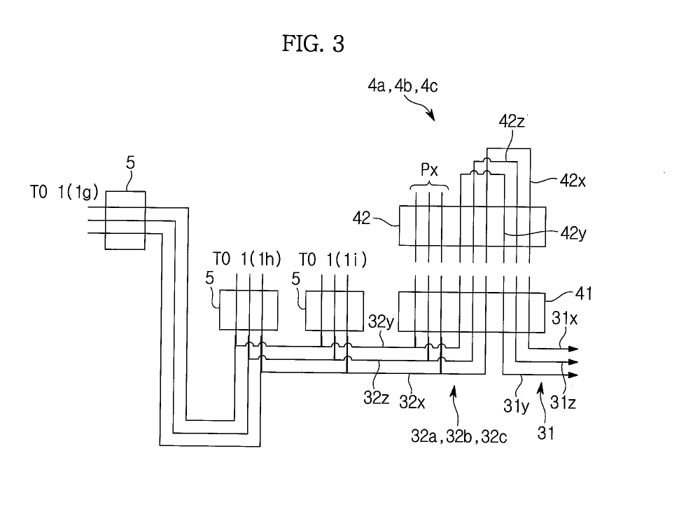

In addition, as illustrated in FIG. 3, the blocking units 4a to 4c may have expandability in which a preliminary connection port Px is pre-installed at the second connector 42 and may connect an additional slave device 1.

In addition, the blocking units 4a to 4c are installed at inner walls (for example, inner walls or upper walls) of the storage compartments R1 to R3 and are configured so that a user may manipulate the blocking units 4a to 4c in a state in which doors of the storage compartments R1 to R3 are opened. In detail, the first connector 41 of the blocking units 4a to 4c is fixed to the inner walls of the storage compartments R1 to R3, and the user may attach and detach the second connector 42 of the blocking units 4a to 4c to and from the first connector 41 in a state in which the doors of the storage compartments R1 to R3 are opened. In addition, by using the blocking units 4a to 4c according to the current embodiment, the number of parts that perforate and connect to an inner case of the refrigerator 100 (perforated parts of the inner case) may be minimized, and loss of an insulating material when a foam insulating material (a urethane foam, etc.) foams may be prevented.

In addition, an access connector 5 that allows the plurality of slave devices connected to the sub-transmission lines 32a to 32c to be individually detached from one another is installed at each of the sub-transmission lines 31a to 32c. The access connector 5 is installed at the inner walls (for example, the inner walls or the upper walls) of the storage compartments R1 to R3, like the blocking units 4a to 4c, and includes a first connector 51 fixed to the inner walls and a second connector 52 installed to be attachable to detachable from the first connector 51. Each of the slave devices 1 is connected to the second connector 52. In addition, although a specific slave device 1 is shown as being connected one-to-one to each access connector 5 in FIG. 1, etc., any slave device 1 may be connected to each access connector 5.

In a state in which one among the plurality of sub-transmission lines 32a to 32c is separated from the main transmission line 31 by the blocking units 4a to 4c, the master device 2 continuously operates using the slave devices 1 connected to the remaining sub-transmission lines 32a to 32c. In detail, the master device 2 specifies the sub-transmission line (for example, the sub-transmission line 32a in the refrigerator compartment R1) separated by the blocking units 4a to 4c, converts the sub-transmission line into a control sequence (a control sequence excluding the refrigerator compartment R1) by sub-transmission lines (for example, the sub-transmission lines 32b and 32c in the temperature-changing compartment R2 and the refrigerator compartment R3) in a connection state excluding the separated sub-transmission line 32a, and continuously operates using the slave devices 1 installed in the sub-transmission lines (for example, the sub-transmission lines 32b and 32c in the temperature-changing compartment R2 and the freezer compartment R3) in the connection state.

According to the refrigerator 100 having the above configuration, since the plurality of sub-transmission lines 32a to 32c that serially connect the plurality of slave devices 1 installed in each of the plurality of storage compartments R1 to R3 are configured to be separable from the main transmission line 31 by the blocking units 4a to 4c, a storage compartment in which abnormal slave devices 1 are installed (for example, the remaining storage compartments other than the refrigerator compartment R1 (for example, the temperature-changing compartment R2 and the freezer compartment R3)) may be continuously operated. In addition, in this state, because the abnormal slave devices 1 may be specified from among the slave devices 1 installed in the sub-transmission line 32a separated from the main transmission line 31, the abnormal slave devices may be easily detected. In addition, since the sub-transmission lines 32a to 32c are installed in each of the storage compartments. R1 to R3, manufacture of the refrigerator 100, such as wiring of the transmission line 3, may be easily performed. Furthermore, a terminating connector may be unnecessary.

In addition, in the current embodiment, because each of the slave devices 1 has a CPU, although each of the slave devices 1 does not select a connector to connect to but connects to any connector, data transceiving between each of the slave devices 1 and the master device 2 may be performed and an operation may be performed.

### Modified Example of First Embodiment

In addition, the present invention is not limited to the first embodiment.

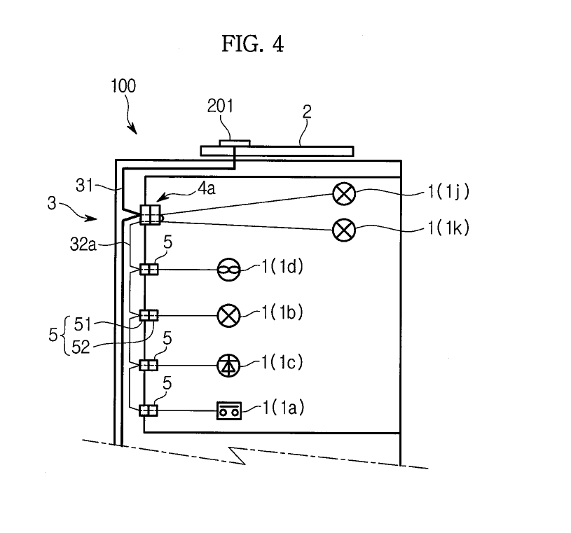

For example, the blocking units 4a to 4c may have connection ports to which additional slave devices or external devices may be connected. In detail, as illustrated in FIG. 4, for example, when a humidity sensor 1j and a gas sensor 1k are added to the refrigerator compartment R1 due to a change of a design specification, use the first connector 41 of the blocking units 4a to 4c as a connection port is considered. That is, exchanging the second connector 42 of the blocking units 4a to 4c and adding the humidity sensor 1j and the gas sensor 1k is considered. In detail, it is considered that the additional humidity sensor 1j and the gas sensor 1k may be connected to a port of the first connector 41 into which the second connector 42 is inserted. Thus, only the second connector 42 of the blocking units 4a to 4c has to be exchanged without needing to change other transmission lines (wire harnesses) or the access connector 5 so that additional slave devices or external devices may be very easily and cheaply corresponded to connectors of the blocking units 4a to 4c.

In addition, in the above embodiment, autonomous distributed control of all the slave devices 1 has been performed. However, centralized control may be performed between a part of the slave devices 1 and the master device 2. For example, slave devices, such as refrigerator compartment LEDs or water dispensers, which require immediate conformity, may be centrally controlled.

### Second Embodiment

Next, a refrigerator using a device control system according to a second embodiment of the present invention will be described with reference to the attached drawings.

A refrigerator 100 according to the current embodiment includes a plurality of slave devices 10, a master device 2 that controls the plurality of slave devices 10, a transmission line 3 that includes a power line 3A connected to an AC power supply 4 and a bus line 3B that enables data communication between the plurality of slave devices 10 and the master device 2 and data communication between the plurality of slave devices 10, and a current detector 6 that is installed on the transmission line 3 and detects a current flowing through the transmission line 3.

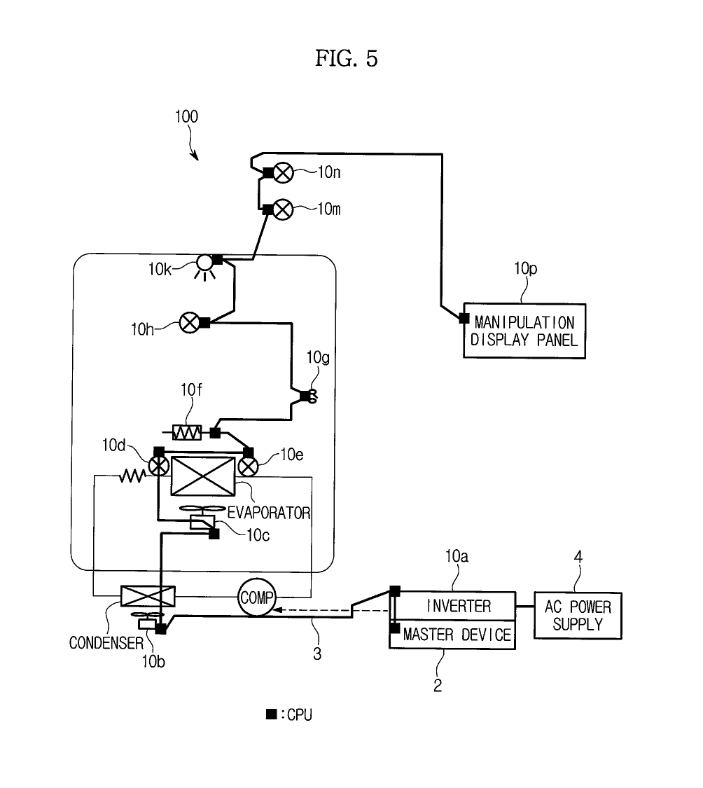

The plurality of slave devices 10 are devices that perform a part of functions of the refrigerator 100. The plurality of slave devices 10 according to the current embodiment are serially connected to one another by one transmission line 3 (the bus line 3B), as illustrated in FIG. 5. In addition, the slave devices 10 in the current embodiment include, in order of connection to the transmission line 3, an inverter 10a, a condenser fan 10b, an evaporator fan 10c, an evaporator inlet temperature sensor 10d, a defrosting sensor 10e, a defrosting heater 10f, a door switch 10g, a refrigerator inner temperature sensor 10h, refrigerator inside lighting 10k, a refrigerator outer temperature sensor 10m, a refrigerator outer humidity sensor 10n, a manipulation display panel 10p, etc.

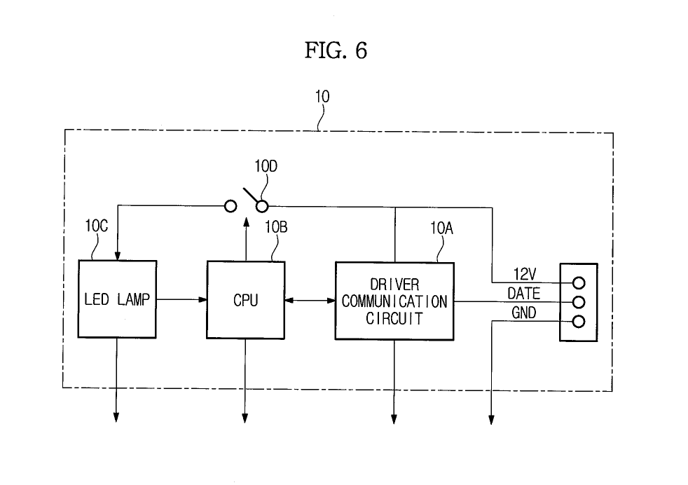

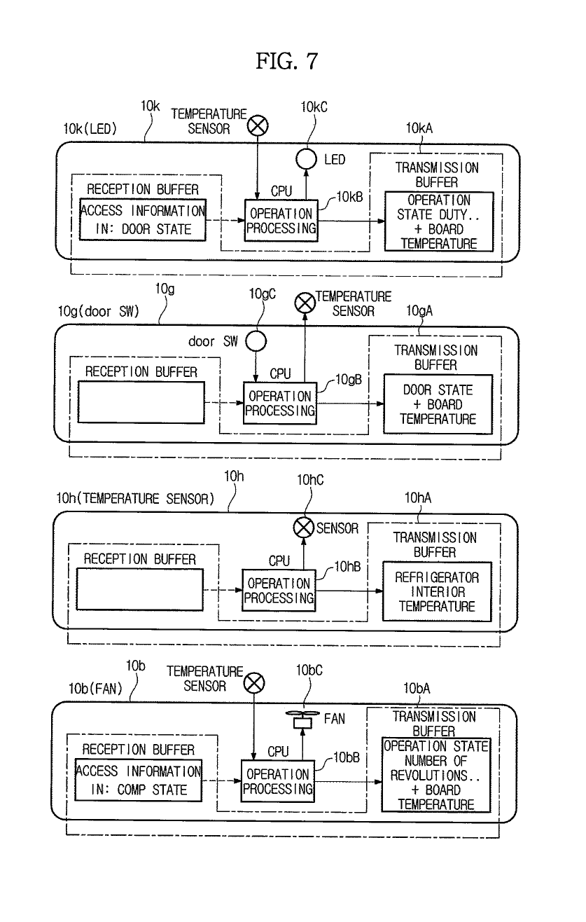

Each of the slave devices 10 includes a communication circuit 10A, a CPU 10B, an operating portion 10C that performs a particular function, and a switch 10D that switches power of the operating portion 10C on/off, as illustrated in FIGS. 6 and 7. In this case, the particular function performed by the operating portion 10C means a function of the operating portion 10C required in a refrigerator, such as a switch, a fan, a sensor, etc., which will be described later

For example, the refrigerator inside lighting 10k includes a communication circuit 10kA, a CPU 10kB, an LED 10kC that is an operating portion, and a switch 10kD. Here, even in a configuration of each of the slave devices 10 except for the refrigerator inside lighting 10k, a basic configuration of each of the slave devices 10 excluding the operating portion 10C is the same as that of the refrigerator inside lighting 10k. For example, in the case of the door switch 10g, an operating portion 10gC thereof is a switch, in the case of the condenser fan 10b, an operating portion 10bC thereof is a fan, and in the case of the refrigerator inner temperature sensor 10h, an operating portion 10hC thereof is a sensor.

In the current embodiment, a state of each of the slave devices 10 includes an initial mode in which no power is supplied to the operating portion 10C, i.e., the switch 10D is off, and a normal mode in which power is supplied to the operating portion 10C, i.e., the switch 10D is on.

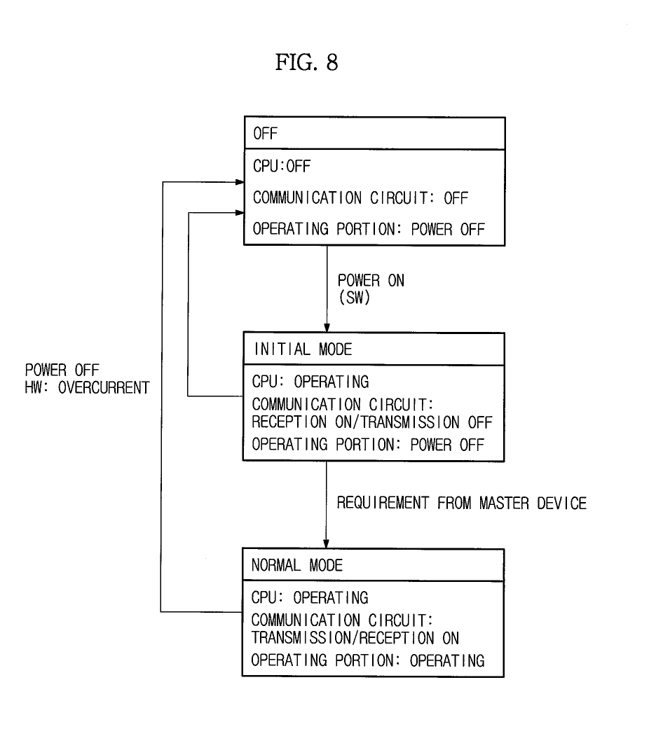

In detail, as illustrated in FIG. 8, the initial mode is a state in which a reception function of the communication circuit 10A is on, the CPU 10B is on, a transmission function of the communication circuit 10A is off and an operating portion 10C is off (the switch 10D is off). In addition, the normal mode is a state in which a transmission/reception function of the communication circuit 10A is on, the CPU 10B is on and the operating portion 10C is on (the switch 10D is on).

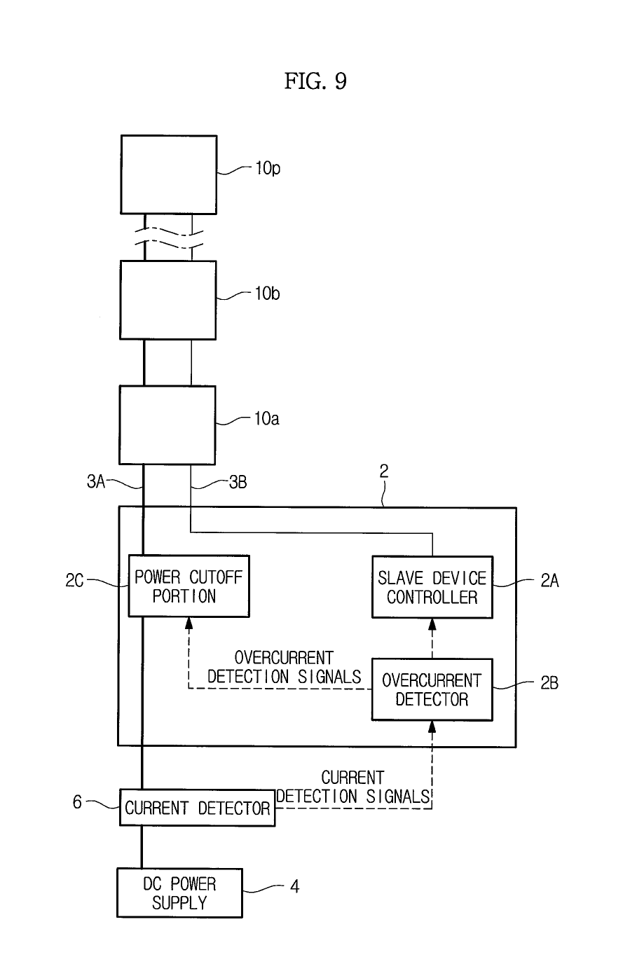

The master device 2 performs data communication with each of the slave devices 10 through LIN communication and converts each of the slave devices 10 to be in the initial mode and the normal mode, as illustrated in FIGS. 5 and 9.

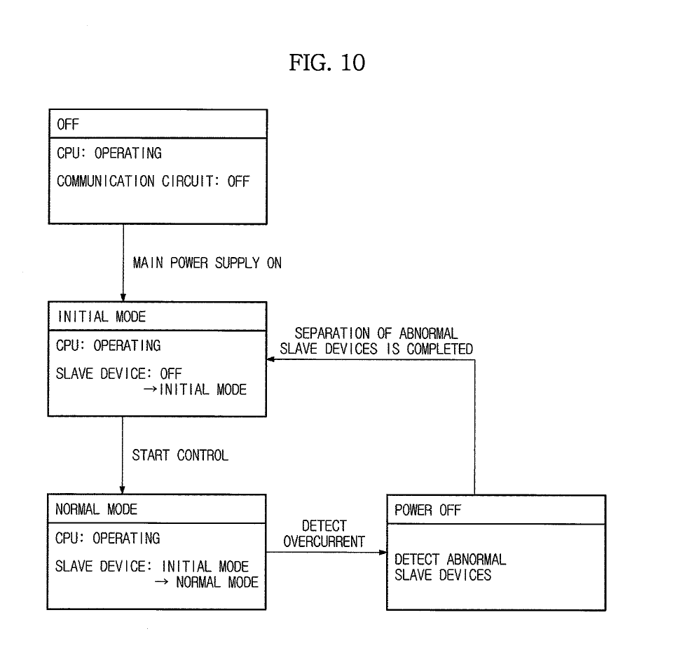

The master device 2 in the current embodiment is installed on a control board installed in the slave devices 10. In more detail, the master device 2 is installed on a control board of the inverter 10a. In addition, a state of the master device 2 immediately after the master device 2 operates is in a power on state, as illustrated in FIG. 10, and includes an initial mode, in which the master device 2 converts each of the slave devices 10 from an off state into the initial mode, and a normal mode, in which the master device 2 converts each of the slave devices 10 from the initial mode into the normal mode.

In detail, the master device 2 that is a computer circuit including a CPU, an internal memory, an AD converter, an input/output interface, etc. performs functions of a slave device controller 2A, an overcurrent detector 2B, and a power cutoff portion 2C when the CPU and peripheral devices of the master device 2 cooperate based on a predetermined program stored in the internal memory.

The slave device controller 2A transmits control signals to each of the slave devices 10, thereby converting each of the slave devices 10 to be in the initial mode and the normal mode. Also, the remaining functions of the slave device controller 2A will be described later.

The overcurrent detector 2B obtains current detection signals from the current detector 6 installed in the power line 3A, determines that an overcurrent is generated when a current value indicated by the current detection signals is higher than a predetermined threshold value, and inputs overcurrent detection signals into the slave device controller 2A and the power cutoff portion 2C. Here, the current detector 6 may be installed on an AC control board installed outside a cooling compartment or a refrigerator compartment, and is installed on the control board of the inverter 10a in the current embodiment.

The power cutoff portion 2C temporarily cuts off a power supply of all the slave devices 10 to reset the CPUs of all the slave devices 10 when the overcurrent detection signal is obtained from the overcurrent detector 2B or the slave device controller 2A.

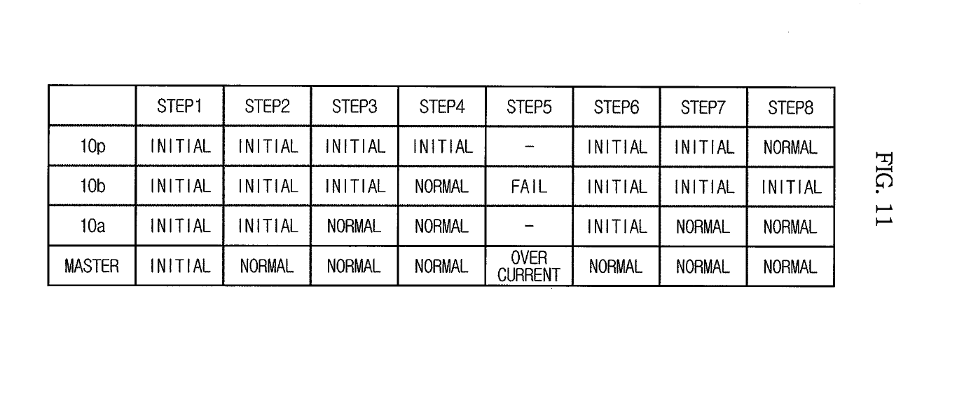

Hereinafter, an example of an operation of the refrigerator 100 according to the current embodiment will be described with reference to FIG. 11.

First, immediately after power is supplied to the refrigerator 100, all of the slave devices 10 and the master device 2 operate in the initial mode (step 1). Thereafter, only the master device 2 operates in the normal mode (step 2).

Next, the slave device controller 2A of the master device 2 transmits control signals to each of the slave devices 10 and converts each of the slave devices 10 from the initial mode into the normal mode in a predetermined sequence. In detail, the slave device controller 2A converts a first slave device 10 (for example, the inverter 10a) to be in the normal mode (step 3), and then converts a second slave device 10 (for example, the condenser fan 10b) to be in the normal mode (step 4). When, the slave devices 10 are sequentially converted to be in the normal mode in this way and the overcurrent detector 2B does not detect any overcurrent, the slave device controller 2A converts all of the slave devices 10 to be in the normal mode.

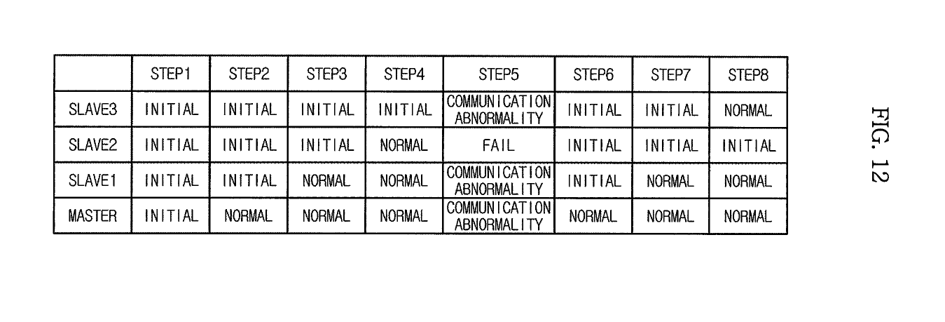

Here, a case where the overcurrent detector 2B detects an overcurrent will be described. In one example, in step 4 of FIG. 12, a case where an overcurrent is generated immediately after the second slave device 10 (for example, the condenser fan 10b) is converted to be in the normal mode will be described.

In step 4, immediately after the second slave device 10 (for example, the condenser fan 10b) is converted to be in the normal mode, for example, when a current value flowing through the transmission line 3, i.e., the sum of consumed power of all of the slave devices 10 to which power is supplied by the transmission line 3, exceeds a predetermined threshold value, which is 15 W stipulated in an International Electrotechnical Commission (IEC) standard (when a voltage of the transmission line 3 is 12 V, 1.25 A), the overcurrent detector 2B inputs overcurrent detection signals into the slave device controller 2A and the power cutoff portion 2C. The power cutoff portion 2C that obtains the overcurrent detection signal temporarily cuts off a power supply to the power line 3A. In addition, the slave device controller 2A determines the second slave device 10 (for example, the condenser fan 10b) converted to be in the normal mode immediately before the overcurrent detection signals were obtained as abnormal slave devices and records data thereof (step 5).

Thereafter, the slave device controller 2A restarts the power supply and resets all of the slave devices 10 to be in the initial mode (step 6). Here, the master device 2 may be reset to be in the normal mode.

The slave device controller 2A converts normal slave devices 10 except for the abnormal slave devices determined in step 5 from the initial mode into the normal mode in the predetermined sequence. In detail, the slave device controller 2A converts the first slave device 10 (for example, the inverter 10a) to be in the normal mode (step 7), and then sets the abnormal slave devices to be in the initial mode and converts a third slave device 10 (for example, the manipulation display panel 10p) to be in the normal mode (step 8). In this way, in a state in which the abnormal slave devices are converted to be in the initial mode, the remaining normal slave devices 10 are sequentially converted to be in the normal mode.

Thus, all of the slave devices 10 except for an abnormal slave device 10f may perform a part of functions of the refrigerator 100.

According to the refrigerator 100 having the above configuration, when an abnormality, such as an overcurrent, occurs in a part of the plurality of slave devices 10 that constitute the refrigerator 100, slave devices 10 are determined as abnormal slave devices and the remaining normal slave devices 10 are converted to be in the normal mode so that functions of the slave devices 10 may be performed and an inside of the refrigerator 100 may be prevented from failing to be cooled.

In addition, even when the master device 2 and the plurality of slave devices 10 are connected in a loop shape to one another by one transmission line 3, abnormal slave devices may be exactly detected, only the remaining normal slave devices 10 may be converted to be in the normal mode, and the functions of the slave devices 10 are performed by the normal slave devices 10 being converted to be in the normal mode. Thus, the master device 2 and the plurality of slave devices 10 are connected to one another by the one transmission line 3 so as to reduce wiring so that the inside of the refrigerator 100 may be prevented from failing to be cooled.

### Modified Example of Second Embodiment

In addition, the present invention is not limited to the second embodiment.

For example, when the current detector 6 is not installed and data communication between the slave device controller 2A of the master device 2 and the communication circuit 10A of one of the slave devices 10 is disabled, the slave devices 10 may be determined as abnormal slave devices, and only the remaining normal slave devices 10 may be converted to be in the normal mode in the predetermined sequence. Control in this case will be described later. In addition, control up to step 4 and control after step 6 are the same as those of the above embodiment and thus, a description thereof will be omitted.

As illustrated in FIG. 12, in step 4, when a communication abnormality (communication disabling) occurs between the master device 2 and the slave device 10b immediately after the second slave device 10 (for example, the condenser fan 10b) is converted to be in the normal mode, the slave device controller 2A determines the slave device 10b as an abnormal slave device and records data thereof (step 5).

Thus, even when the communication abnormality occurs in a part of the plurality of slave devices 10 that constitute the refrigerator 100, the slave devices 10 are determined as the abnormal slave devices, and the remaining normal slave devices 10 are converted to be in the normal mode so that the function of the slave devices 10 is performed and the inside of the refrigerator 100 may be prevented from failing to be cooled.

In addition, when the master device 2 determines one of the slave devices 10 as the abnormal slave devices, the master device 2 converts only the normal slave devices 10 to be in the normal mode and furthermore, alternately converts the abnormal slave devices to be in the initial mode and the normal mode on a predetermined cycle so as to check whether the abnormality is solved.

Thus, when the abnormality of the abnormal slave devices is a temporary abnormality, functions of all of the slave devices 10 are performed after the abnormality is solved so that all of functions of the refrigerator 100 may be performed.

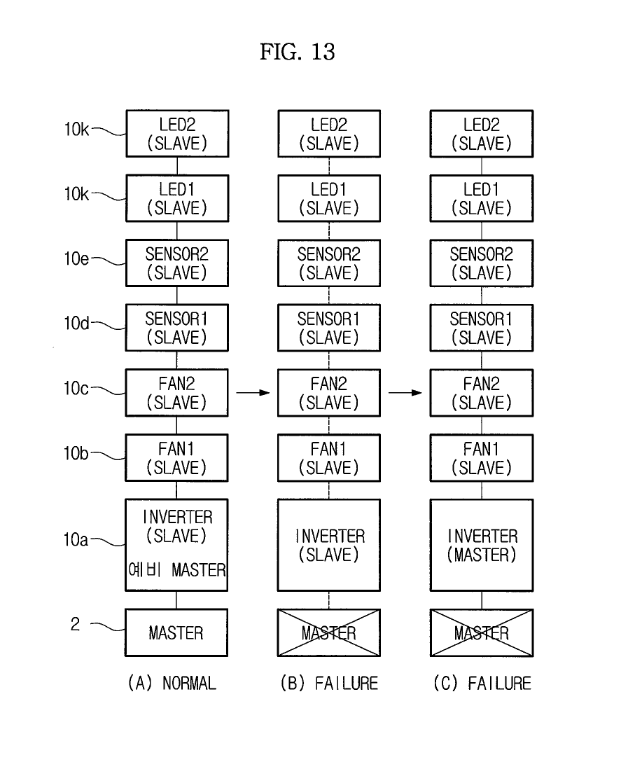

Through the above configuration, when one among the plurality of slave devices 10 is determined as a preliminary master device that replaces the master device 2, although an abnormality occurs in the master device 2 and a communication disabled state is established, the preliminary master device detects that a determination of the abnormal slave devices is not performed. The preliminary master device may then replace the master device 2 so that the preliminary master device and the normal slave devices continuously operate by maintaining communication therebetween. For example, as illustrated in FIG. 13(A), the refrigerator 100 includes the master device 2 installed on the control board of the inverter 10a, the inverter 10a, the condenser fan 10b, the evaporator fan 10c, and the evaporator inlet temperature sensor 10d that are the slave devices 10. The control board of the inverter 10a itself is determined as the preliminary master device. In addition, the control board CPU of the slave devices 10 except for the inverter 10a may be determined as the preliminary master device. In the refrigerator having the above configuration, in a normal state, the master device 2 controls each of the slave devices 10. Meanwhile, when the master device 2 breaks down, the control board of the inverter 10a that is a predetermined preliminary master device detects a failure of the master device 2 (FIG. 13(B)). The control board of the inverter 10a that is the preliminary master device performs a function of the master device 2 and controls the remaining normal slave devices 10 (FIG. 13(C)).

Thus, when an abnormality, such as communication disabling or a failure in a communication circuit, occurs in the master device 2, the preliminary master device replaces the master device 2 and maintains communication with the normal slave devices so that functions of the normal slave devices are performed and the inside of the refrigerator 100 may be prevented from failing to be cooled.

In each of the above embodiments, a refrigerator equipped with a device control system has been described. However, an on-board device control system for controlling an on-board device may be applied, and a device control system for controlling a device mounted on a moving body, such as a subway, an airplane, a ship, etc., may be applied. In addition, the device control system may be mounted on one of home appliances excluding the refrigerator and may be applied as a part of a home network, etc.

While the invention has been shown and described with reference to certain exemplary embodiments thereof, it should be understood by those skilled in the art that various changes in form and details may be made therein without departing from the spirit and scope of the invention as defined by the appended claims.

1. A refrigerator comprising:
a plurality of storage compartments;
a plurality of slave devices installed in each of the plurality of storage compartments and configured to perform functions of the refrigerator;
a master device configured to control the plurality of slave devices;
a transmission line comprising a main transmission line connected to the master device and a plurality of sub-transmission lines branched from the main transmission line and connecting the plurality of slave devices in series, so as to enable data communication between the plurality of slave devices and the master device and to enable mutual data communication between the plurality of slave devices; and
a blocking unit interposed between the main transmission line and each of the plurality of sub-transmission lines such that the sub-transmission lines are separable from the main transmission line,
wherein the plurality of sub-transmission lines are serially connected to the plurality of slave devices installed in each of the plurality of storage compartments.

2. The refrigerator of claim 1, wherein the master device, in a state in which one among the plurality of sub-transmission lines is separated from the main transmission line by the blocking unit, is configured to continuously operate using the slave devices connected to remaining sub-transmission lines.

3. The refrigerator of claim 1, wherein the blocking unit comprises a connector to which an additional slave device or external device is connectable.

4. The refrigerator of claim 1, wherein the blocking unit comprises a first connector installed in a state in which one end of a main transmission line that constitutes the main transmission line and one end of each of sub-transmission lines that constitute the sub-transmission lines are separated from each other, and a second connector which is installed to be attachable to and detachable from the first connector and in which a connection line for connecting one end of the main transmission line and one end of each of the sub-transmission line is installed.

5. The refrigerator of claim 1, wherein an access connector is installed in each of the plurality of sub-transmission lines such that the plurality of slave devices connected to each of the plurality of sub-transmission lines are individually detachable from one another.

6. A refrigerator comprising:
a plurality of storage compartments;
a plurality of slave devices installed in each of the plurality of storage compartments and each comprising:
a central processing unit (CPU),
a communication circuit,
an operating portion configured to perform a specific function, and
a switch configured to switch power of the operating portion on or off;
a master device configured to control the plurality of slave devices;
a transmission line configured to enable data communication between the plurality of slave devices and the master device and enable enabling data communication between the plurality of slave devices; and
a current detector installed on the transmission line and configured to detect a current flowing through the transmission line,
wherein:
the master device is further configured to convert the plurality of slave devices to be in an initial mode, in which no power is supplied to operating portions and functions of the slave devices are not operated by switches, and a normal mode in which power is supplied to the operating portions and the functions of the slave devices are operated by the switches, and
when the master device converts one among the slave devices from the initial mode into the normal mode, the master device is further configured to check whether a current value that is equal to or higher than a threshold value is detected using the current detector, and
as a result of the checking, when the current value equal to or higher than the threshold value is detected, the master device is further configured to determine the slave devices as abnormal slave devices and convert only remaining normal slave devices to be in the normal mode.

7. The refrigerator of claim 6, wherein, when the master device converts the plurality of slave devices from the initial mode into the normal mode and the abnormal slave devices are detected, the master device is further configured to convert all of the plurality of slave devices to be in the initial mode and then convert the normal slave devices excluding the abnormal slave devices to be in the normal mode.

8. A refrigerator comprising:
a plurality of storage compartments;
a plurality of slave devices installed in each of the plurality of storage compartments and each comprising:
a central processing unit (CPU),
a communication circuit, and
an operating portion configured to perform a specific function;
a master device configured to control the plurality of slave devices; and
a transmission line configured to enable data communication between the plurality of slave devices and the master device and enable data communication between the plurality of slave devices,
wherein:
the master device is further configured to convert the plurality of slave devices to be in an initial mode, in which each of the slave device performs only data receiving, and a normal mode, in which each of the slave device performs data transceiving, and
when the master device converts one among the slave devices from the initial mode into the normal mode and then data communication with the slave device is disabled, the master device is further configured to determine the slave devices as abnormal slave devices and convert only remaining normal slave devices to be in the normal mode.

9. The refrigerator of claim 8, wherein one among the plurality of slave devices is set as a preliminary master device, and when an abnormality occurs in the master device, the preliminary master device is configured to continuously operate by maintaining communication with the normal slave devices.

10. A device control system comprising:
a plurality of slave devices;
a master device configured to control the plurality of slave devices;
a transmission line comprising a main transmission line connected to the master device and a plurality of sub-transmission lines branched from the main transmission line and connecting the plurality of slave devices in series, so as to enable data communication between the plurality of slave devices and the master device and to enable mutual data communication between the plurality of slave devices; and
a blocking unit interposed between the main transmission line and each of the plurality of sub-transmission lines such that the sub-transmission lines are separable from the main transmission line.

11. The device control system of claim 10, wherein the master device, in a state in which one among the plurality of sub-transmission lines is separated from the main transmission line by the blocking unit, is further configured to continuously operate using the slave devices connected to the remaining sub-transmission lines.

12. The device control system of claim 10, wherein the blocking unit comprises a connector to which an additional slave device or an external device is connectable.

13. The device control system of claim 10, wherein an access connector is installed in each of the plurality of sub-transmission lines such that the plurality of slave devices connected to each of the plurality of sub-transmission lines are individually detachable from one another.

14. A device control system comprising:
a plurality of slave devices, each comprising:
a central processing unit (CPU),
a communication circuit,
an operating portion configured to perform a specific function, and
a switch configured to switch for switching power of the operating portion on or off;
a master device configured to control the plurality of slave devices;
a transmission line configured to enable data communication between the plurality of slave devices and the master device and enable data communication between the plurality of slave devices; and
a current detector installed on the transmission line and configured to detect a current flowing through the transmission line,
wherein:
the master device is configured to convert the plurality of slave devices to be in an initial mode, in which no power is supplied to operating portions and functions of the slave devices are not operated by switches, and a normal mode, in which power is supplied to the operating portions and the functions of the slave devices are operated by the switches, and
when the master device converts one among the slave devices from the initial mode into the normal mode, the master device is configured to check whether a current value that is equal to or higher than a threshold value is detected using the current detector, and
as a result of the checking, when the current value equal to or higher than the threshold value is detected, the master device is configured to determine the slave devices as abnormal slave devices and convert only remaining normal slave devices to be in the normal mode.

15. The device control system of claim 14, wherein, when the master device converts the plurality of slave devices from the initial mode into the normal mode and the abnormal slave devices are detected, the master device is further configured to convert all of the plurality of slave devices to be in the initial mode and then converts the normal slave devices excluding the abnormal slave devices to be in the normal mode.

16. The device control system of claim 14, wherein one among the plurality of slave devices is set as a preliminary master device, and when an abnormality occurs in the master device, the preliminary master device is further configured to continuously operate by maintaining communication with the normal slave devices.

17. A device control system comprising:
a plurality of slave devices, each comprising:
a central processing unit (CPU),
a communication circuit, and
an operating portion configured to perform a specific function;
a master device configured to control the plurality of slave devices; and
a transmission line configured to enable data communication between the plurality of slave devices and the master device and enable data communication between the plurality of slave devices,
wherein:
the master device is further configured to convert the plurality of slave devices to be in an initial mode, in which each of the slave device performs only data receiving, and a normal mode, in which each of the slave device performs data transceiving, and
when the master device is further configured to convert one among the slave devices from the initial mode into the normal mode and
then data communication with the slave device is disabled, the master device is further configured to determine the slave devices as abnormal slave devices and convert only remaining normal slave devices to be in the normal mode.

18. The device control system of claim 17, wherein, when the master device converts the plurality of slave devices from the initial mode into the normal mode and the abnormal slave devices are detected, the master device is further configured to convert all of the plurality of slave devices to be in the initial mode and then convert the normal slave devices excluding the abnormal slave devices to be in the normal mode.

19. The device control system of claim 17, wherein the master device is further configured to convert the normal slave devices to be in the normal mode and then alternately convert the abnormal slave devices to be in the initial mode and the normal mode on a predetermined cycle to check whether an abnormality is solved.

20. The device control system of claim 17, wherein one among the plurality of slave devices is set as a preliminary master device, and when an abnormality occurs in the master device, the preliminary master device is further configured to continuously operate by maintaining communication with the normal slave devices.
